(19) United States
(12) Patent Application Publication
(10) Pub. No.: US 2003/0041406 A1
(43) Pub. Date: Mar. 6, 2003

(54) VAPOR CLEANER

(76) Inventor: Lambert Wu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/946,342

(22) Filed: Sep. 6, 2001

(51) Int. Cl. B08B 3/02

(52) U.S. Cl. 15/320

(57) ABSTRACT

A vapor cleaner comprises a main body, a heating stove, a conduit and a plurality of brushes. The main body is a hollow casing with two compartments therein, and has an accommodation groove on bottom thereof. The heating stove is fixedly arranged in one compartment and the brushes are placed in another compartment. The conduit has one end screwed to a nozzle of the heating stove and another end connected to a handle. The handle can be locked in the accommodation groove. The brushes not assembled to the handle are stored in another compartment; the handle and the brush assembled therein are locked into the accommodation groove.

### FIELD OF THE INVENTION

The present invention relates to a vapor cleaner, especially to a vapor cleaner with compact size and easy for storage.

### BACKGROUND OF THE INVENTION

The conventional cleaning tools for floor such as mop or brush can only remove dirt from floor and need cleaner for cleaning bacteria. However, the cleaner is generally both harmful for human and environment. The vapor cleaner is developed to use high-temperature vapor for cleaning bacteria and be safe for human and environment.

FIG. 1 shows a prior art vapor cleaner, which comprises a main body 1a containing a heating stove 10a, a water inlet 11a to guide water into the heating stove 10a, and a lid 17a screwed into the water inlet 11a for sealing the heating stove 10 and facilitating the heating of water in the heating stove 10a. The water is heated to vapor and the vapor is emitted through a nozzle 12a atop the heating stove 10. The nozzle 12a is connected to a conduit 13a, a handle 14a and brush 15a of various functions. The high-temperature vapor is emitted through the conduit 13a, the handle 14a and the brush 15a for antisepsis.

The conduit 13a generally has sufficient length such that the brush 15a can access a cabined area. The main body 1a is provided with a shoulder strap 16a for user to carry the vapor cleaner.

However, the above-mentioned vapor cleaner has the problem of hoarding even the conduit 13a can be coiled to reduce its volume. The handle 14a and the brush 15a are generally made of rigid material. Therefore, the above-mentioned vapor cleaner occupies considerable space.

Moreover, if additional water is to be added into the vapor cleaner, the d 17a is unscrewed from the water inlet 11a. However, the user has the risk of scalding by the vapor.

### SUMMARY OF THE INVENTION

It is an object of the present invention to provide a vapor cleaner, which has a handle and a plurality of brushes being able to receive in a main body of the vapor cleaner. The main body of the vapor cleaner can be placed in erected state to save occupied area.

It is another object of the present invention to provide a vapor cleaner, which has a means to block vapor from rushing out of the vapor cleaner when water is to be added in the vapor cleaner.

To achieve the first object, the present invention provides a vapor cleaner, comprising a main body, a heating stove, a conduit and a plurality of brushes. The main body is a hollow casing with two compartments therein, and has an accommodation groove on bottom thereof. The heating stove is fixedly arranged in one compartment and the brushes are placed in another compartment. The conduit has one end screwed to a nozzle of the heating stove and another end connected to a handle. The handle can be locked in the accommodation groove. The brushes not assembled to the handle are stored in another compartment; the handle and the brush assembled therein are locked into the accommodation groove.

To achieve the second object, the present invention provides a vapor cleaner, comprising a lid arranged atop a water inlet and screwed into the water inlet; the lid has a membrane on bottom thereof. Therefore, the membrane blocks vapor from rushing out of the vapor cleaner when water is to be added in the vapor cleaner.

The various objects and advantages of the present invention will be more readily understood from the following detailed description when read in conjunction with the appended drawing, in which:

### BRIEF DESCRIPTION OF DRAWING

FIG. 1 shows an exploded view of a prior art vapor cleaner;

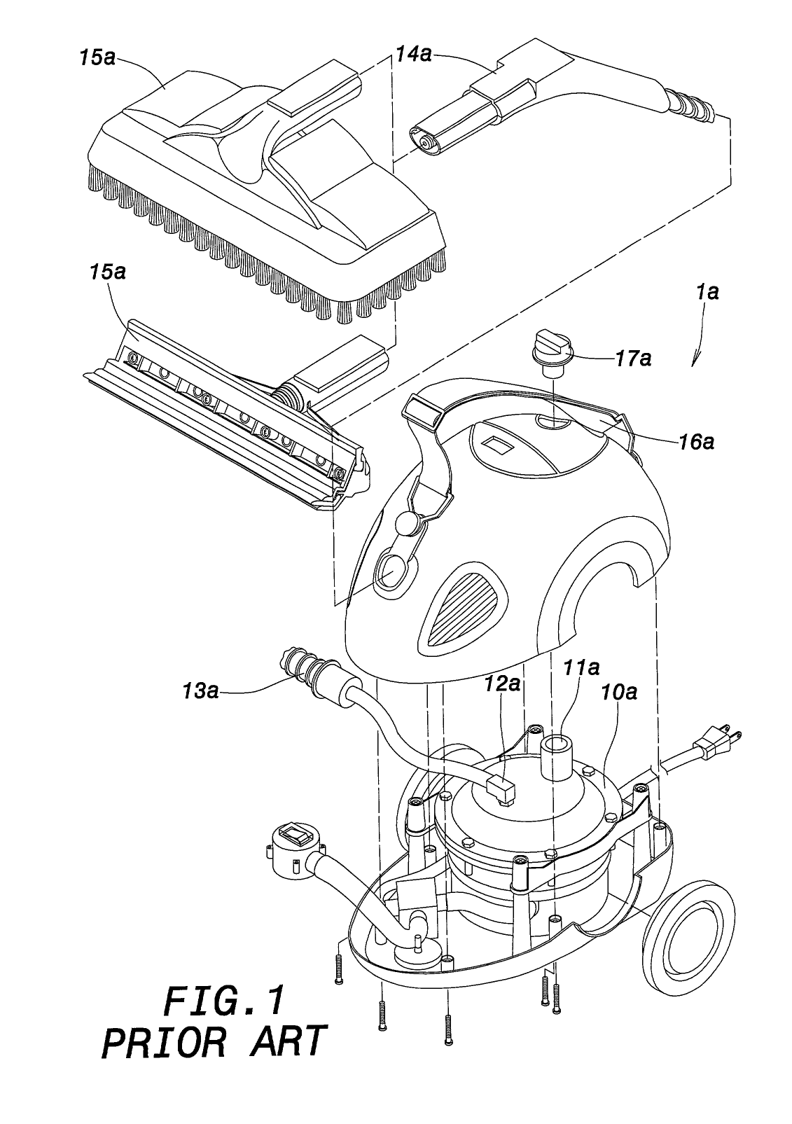

FIG. 2 shows an exploded view of the vapor cleaner of the present invention; and

FIG. 3 shows a perspective view of the vapor cleaner of the present invention.

### DETAILED DESCRIPTION OF THE INVENTION

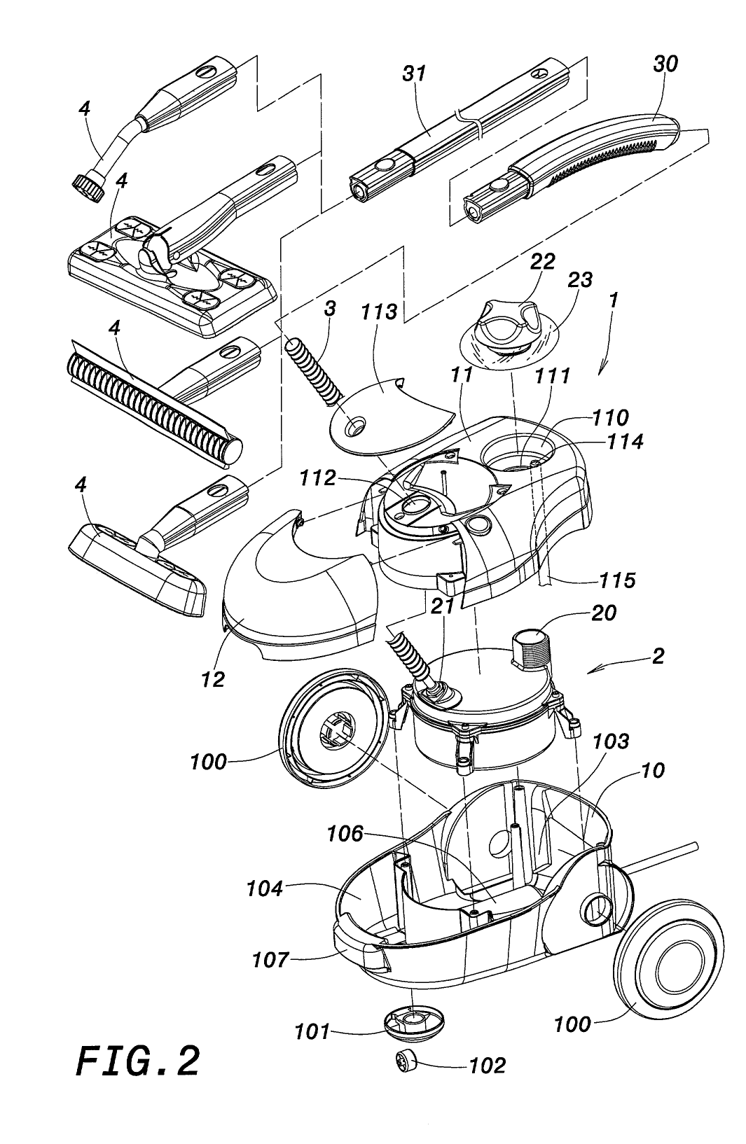

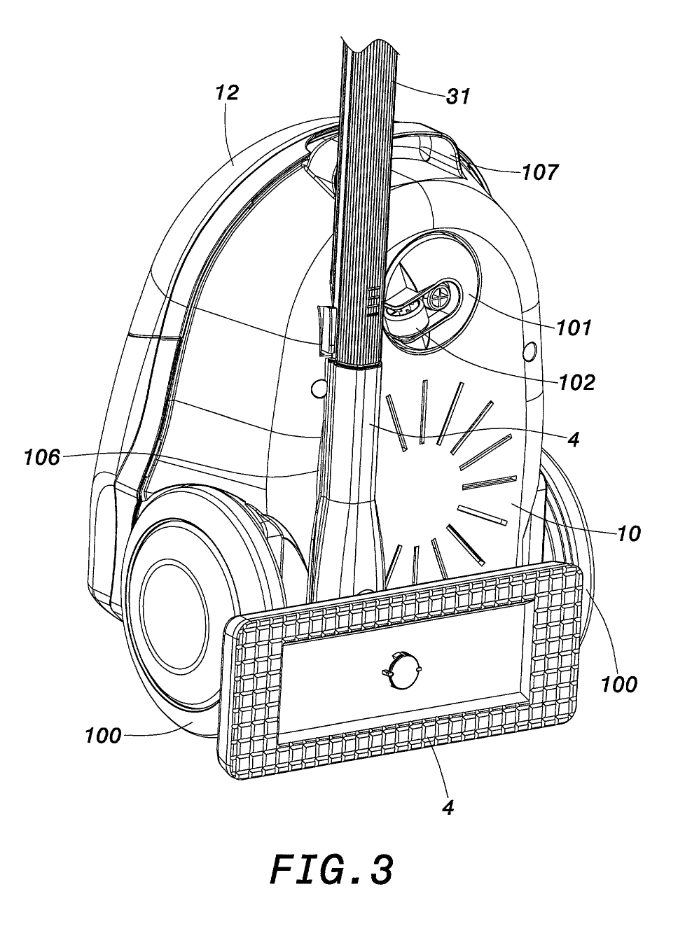

FIG. 2 shows an exploded view and FIG. 3 shows a perspective view of the present invention. The present invention provides a vapor cleaner, comprising a main body 1, a heating stove 2, a conduit 3 and a plurality of brushes 4. The main body 1 comprises a base 10, an upper cover 11 and an openable cover 12. The base 10 is a hollow casing with open topside. The upper cover 11 and the openable cover 12 are hollow casing with open bottom side and assembled to top portion of the base 10 to form a complete hollow casing.

The base 10 has two rear wheels 100 on two lateral bottom sides thereof and a pivotally arranged front wheel 101 at front bottom side thereof. Moreover, an auxiliary front wheel 102 is pivotally arranged on the front wheel 101 to facilitate the movement of the vapor cleaner.

The base 10 comprises two compartments 103 and 104; wherein the heating stove 2 is placed in one compartment 103. The compartment 103 has a plurality of heat-dissipating holes 105 on bottom thereof to facilitate the dissipation of the heat generated by the heating stove 2. The other compartment 104 is used to receive the brushes 4 therein. An accommodation groove 106 is concavely formed on bottom of the compartment 104. The base 10 has a front grip 107 on front side thereof and user can hold the handle 107 to lift the main body 1 in erected state.

The upper cover 11 has an open recess 110 on one side thereof and the open recess 110 has a through hole 111 on bottom thereof. The upper cover 11 further has a nozzle hole 112 on another side thereof and with an open bottom. The upper cover 11 further has a top grip 113 and user can hold the top grip 113 to lift the main body 1 in horizontal state.

The rear side of the openable cover 12 is pivotally connected to the front side of the upper cover 11; and the openable cover 12 is located atop the compartment 104 such that the openable cover 12 can be operated to cover or expose the compartment 104. Therefore, the brushes 4 are be stored in or taken from the compartment 104.

The heating stove 2 is fixedly placed in the compartment 103 and has a nozzle 21 and a water inlet 20. A lid 22 is arranged atop the water inlet 20 and screwed into the water inlet 20. The lid 22 is placed within the open recess 110. The vapor generated in the heating stove 2 is emitted through the nozzle 21.

The lid 22 has a membrane on bottom thereof, which is used to block the high-temperature vapor from rushing through the water inlet 20. The open recess 110 has an aperture 114, and a hose 115 is connected to bottom of the aperture 114. The cooled water can be discharged through the aperture 114 connected to a hose 115.

The conduit 3 is made of heat-resistant materials, and having one end screwed to the nozzle 21 of the heating stove 2 and another end connected to a handle 30. Therefore, the high-temperature vapor is guided to the brush 4 through the nozzle 21, the conduit 3 and the handle 30.

The handle 30 of the conduit 3 can be locked into the accommodation groove 106. The handle 30 of the conduit 3 can further be provided with an extension tube 31 to facilitate the operation of the brush for cabined area.

The brushes 4 have different functions and are connected to the handle 30 or the extension tube 31 in a replaceable way. Therefore, the brushes 4 can be used for different kinds of jobs with high-temperature vapor. Moreover, the brushes 4 can be stored in the compartment 104.

More particular, after the cleaning job is over, the unused brushes 4 can be stored in the compartment 104. The handle 30 and the extension tube 31 connected with one brush 4 can be locked into the accommodation groove 106 to reduce occupied space. Moreover, the main body 1 can be erected to attach on wall to further occupied space.

Moreover, when water is needed to supply to the vapor cleaner, the membrane 23 below the lid 22 can block the high-temperature vapor from rushing through the water inlet 20.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A vapor cleaner comprising
a main body being a hollow casing with two compartments therein and having an accommodation groove on bottom thereof;
a heating stove fixedly arranged in one compartment and having a water inlet and a nozzle;
a conduit having one end screwed to the nozzle of the heating stove and another end connected to a handle, the handle being able to lock in the accommodation groove; and
a plurality of brushes, each of the brushes being detachably assembled to the handle and the brushes being able to store in another compartment;
the brushes not assembled to the handle being stored in another compartment, the handle and the brush assembled therein being locked into the accommodation groove.

2. The vapor cleaner as in claim 1, wherein the main body is composed of a base, an upper cover and an openable cover; the upper cover and the openable cover are arranged atop the base and pivotally assembled to each other.

3. The vapor cleaner as in claim 2, wherein the upper cover has an open recess, the open recess has an aperture and a hose is connected to bottom of the aperture.

4. The vapor cleaner as in claim 1, wherein the base has two rear wheels on two lateral bottom sides thereof and a pivotally arranged front wheel at front bottom side thereof, an auxiliary front wheel pivotally arranged on the front wheel.

5. The vapor cleaner as in claim 1, wherein the main body has a front grip on front side thereof.

6. The vapor cleaner as in claim 1, wherein the main body has a top grip.

7. The vapor cleaner as in claim 1, wherein one compartment has a plurality of heat-dissipating holes on bottom thereof.

8. The vapor cleaner as in claim 1, wherein a lid is arranged atop the water inlet and screwed into the water inlet, the lid has a membrane on bottom thereof.

9. The vapor cleaner as in claim 1, wherein the handle is connected to an extension tube.

10. The vapor cleaner as in claim 9, wherein the extension tube can also be locked into the accommodation groove.

11. The vapor cleaner as in claim 1, wherein the brushes have different functions.
